(19) United States
(12) Patent Application Publication
(10) Pub. No.: US 2008/0169994 A1
(43) Pub. Date: Jul. 17, 2008

(54) ANTENNA DEVICE

(75) Inventor: Minoru HASEGAWA, Yokohama-shi (JP)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/962,951

(22) Filed: Dec. 21, 2007

(30) Foreign Application Priority Data
Dec. 22, 2006 (JP) 346328/2006
May 17, 2007 (KR) 48143/2007

(51) Int. Cl. H01Q 19/10

(52) U.S. Cl. 343/834

(57) ABSTRACT

An antenna device can be designed using a micro-strip array antenna designing method while improving a F/B ratio, and resisting wind pressure load despite small size and lightweight. The antenna device includes an array antenna having a plurality of radiation elements arranged on one surface of a rectangular ground plate composed of a short side and a long side and a reflector having a conductive material whose cross section is nearly a half cylinder in a circular arc shape, in which a width between parallel linear end portions corresponding to an arc of the cross section is longer than the short side of the ground plate. The array antenna is disposed such that the other surface of the ground plate faces inner wall of a depression part of the reflector and the ground plate is disposed in the same plane as or in nearly the same plane as each of the linear end portions of the reflector.

### PRIORITY

This application claims priority under 35 U.S.C. § 119(a) to a Korean Patent Application filed in Japanese Patent Office on Dec. 22, 2006 and assigned Serial No. 346328/2006, and an application filed in the Korean Intellectual Property Office on May 17, 2007 and assigned Serial No. 2007-48143, the entire disclosure of which are hereby incorporated by reference.

### BACKGROUND OF THE INVENTION

1. Field of the Invention

The present invention generally relates to an antenna for a base station in a mobile communication system, and in particular, to a base station antenna device constituting a sector zone.

2. Description of the Related Art

In the base station antennas for the 2nd-Generation (2G) mobile communication terminals and their former terminals, sector zone configuration has not been spread widely and horizontal plane directivity has been formed to omnidirectionally output and receive electric waves. In the base station antennas for the 3rd-Generation (3G) mobile communication terminals and their latter terminals, sector zone configuration is spread and a beam is output in a direction directed by a base station antenna to prevent interference between section zones. In the base station antennas for the 4th-Generation (4G) mobile communication terminals, sector zone configuration further progresses and the performance of communication between adjoining sector zones may degrade due to a leakage of electric waves from one of the sector zones because the sector zones may communicate with each other in the same frequency band using different codes or other ways.

For that reason, in the base station antennas for the 4G mobile communication terminals or their latter terminals, it is preferable that an antenna gain in sector directions other than the direction of a current servicing sector is low because interference caused by an antenna for a nearby sector adjoining the servicing sector may deteriorate communication quality or handover performance. In this context, the Front-to-Back (F/B) ratio of an antenna, i.e., the ratio of a gain in the maximum gain direction, i.e., a gain in front of the antenna, to a gain in the minimum gain direction, i.e., a gain in back of the antenna, has to be high.

An example of an antenna having such directivity has been disclosed in Japanese Patent Publication No. 2001-196830. The disclosed antenna is an array antenna that has a dipole antenna as its fundamental element and is combined with a reflection board. However, the array antenna has some problems in its design and use such as proper selection of the arrangement position and fixing method of a feeding circuit for the antenna. A micro-strip array antenna has been widely used as an antenna with directivity because of its easy design. In the micro-strip array antenna, a radiation element is attached to one surface of a flat plate and a feeding circuit is disposed in the other surface of the flat plate. The micro-strip array antenna is advantageous over a dipole antenna in terms of the disposition of the feeding circuit, design, and manufacturing.

In the micro-strip array antenna, the size of the flat plate has to be large to increase the F/B ratio, but in practice, the size of the flat plate is limited, making it difficult to increase the F/B ratio over 20 dB. Moreover, the size of a sector zone tends to decrease as a new generation emerges and an antenna device has to be light-weight and miniaturized to be attached to anywhere. Furthermore, the antenna device should have small wind pressure load and a shape allowing sufficient solidity because of being installed in an outdoor environment. It is preferable that the number of parts of the antenna device is small for easy design, manufacturing, and repair.

### SUMMARY OF THE INVENTION

An aspect of the present invention is to address at least the above problems and/or disadvantages and to provide at least the advantages described below. Accordingly, an aspect of the present invention is to provide an antenna device with a small-size and light-weight shape, which can improve an F/B ratio by at least 10 dB and resist wind pressure load while being designed according to a micro-strip array antenna designing method.

In accordance with an aspect of the present invention, there is provided an antenna device including an array antenna comprising a plurality of radiation elements arranged on one surface of a rectangular ground plate having a short side and a long side and a reflector having a conductive material whose cross section is nearly a half cylinder in an circular arc shape, in which a width between parallel linear end portions corresponding to an arc of the cross section is longer than the short side of the ground plate, in which the array antenna is disposed such that the other surface of the ground plate faces the inner wall of a depression part of the reflector and the ground plate is disposed in the same plane as or in nearly the same plane as each of the linear end portions of the reflector.

Preferably, the reflector is composed of a lateral side of a cylinder taken along a plane including the principal axis of the cylinder. Preferably, if when the antenna device uses a wavelength of λ, a width between the linear end portions of the reflector is nearly 2λ and the length of the short side of the ground plate is nearly 0.5-1.5λ. Preferably, the reflector includes a metal plate, a metal net, or a dielectric coated with metal. Preferably, only the array antenna is accommodated in a resin radome, or preferably, both the array antenna and the reflector are accommodated in a resin radome. Preferably, the reflector is formed by coating the inner circumferential surface of the radome with metal. Preferably, the reflector is formed of a metal net by etching in the inner circumferential surface of the radome.

### BRIEF DESCRIPTION OF THE DRAWINGS

The above and other features and advantages of an exemplary embodiment of the present invention will become more apparent from the following detailed description when taken in conjunction with the accompanying drawings, in which:

FIG. 1 illustrates a basic structure of an antenna device according to an exemplary embodiment the present invention;

FIG. 2 illustrates a feeding structure for a radiation element for explaining a feeding method;

FIG. 3 is a perspective view of an antenna device according to the present invention;

FIG. 4 is a graph showing the characteristics of the F/B ratio of an antenna device; and

FIGS. 5A and 5B illustrate a mounting structure for an antenna device of the present invention.

### DETAILED DESCRIPTION OF THE EXEMPLARY EMBODIMENTS

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

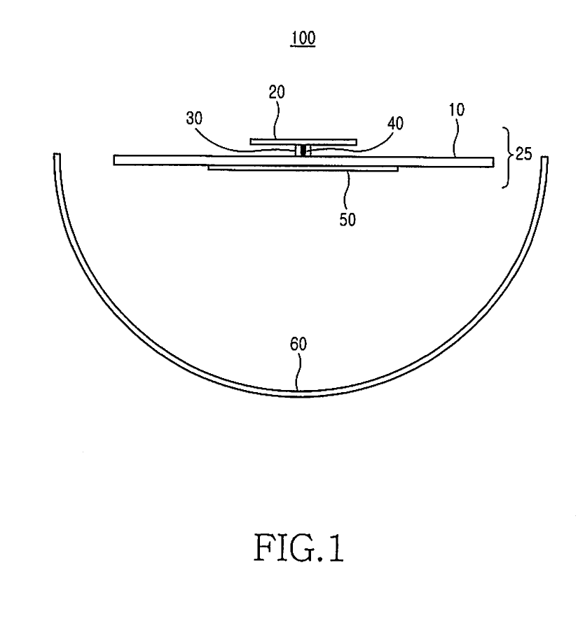

FIG. 1 illustrates the basic structure of an antenna device 100 of the present invention. The antenna device 100 includes an array antenna 25 and a reflector 60.

The array antenna 25 is configured in such a manner that a plurality of radiation elements 20 are arranged by a support member 30 on one surface of a rectangular ground plate 10 composed of a short side and a long side, a feeding circuit 50 is disposed on the other surface of the ground plate 10, and the plurality of radiation elements 20 and the feeding circuit 50 are connected with each other through a feeding unit 40. The reflector 60 is composed of a lateral side of a cylinder in which the cross section of the cylinder taken along a plane parallel with the principal axis of the cylinder has a width that is longer than its short side. The array antenna 25 is disposed such that the other surface of the ground plate 10 faces a depression part of the lateral side of the cylinder of the reflector 60 and the ground plate 10 is disposed in nearly the same plane as the cross section of the cylinder.

It is preferable that the reflector 60 of the antenna device 100 is composed of a lateral side of a cylinder taken along a plane containing the principal axis of the cylinder. Preferably, the reflector 60 includes a metal plate, a metal net, or a dielectric coated with metal. If the antenna device 100 uses a wavelength of λ, a width between linear end portions of the reflector 60 is nearly 2λ and the length of a short side of the ground plate 10 is nearly 0.5-1.5λ. The length of the short side of the ground plate 10 is determined by a beam width.

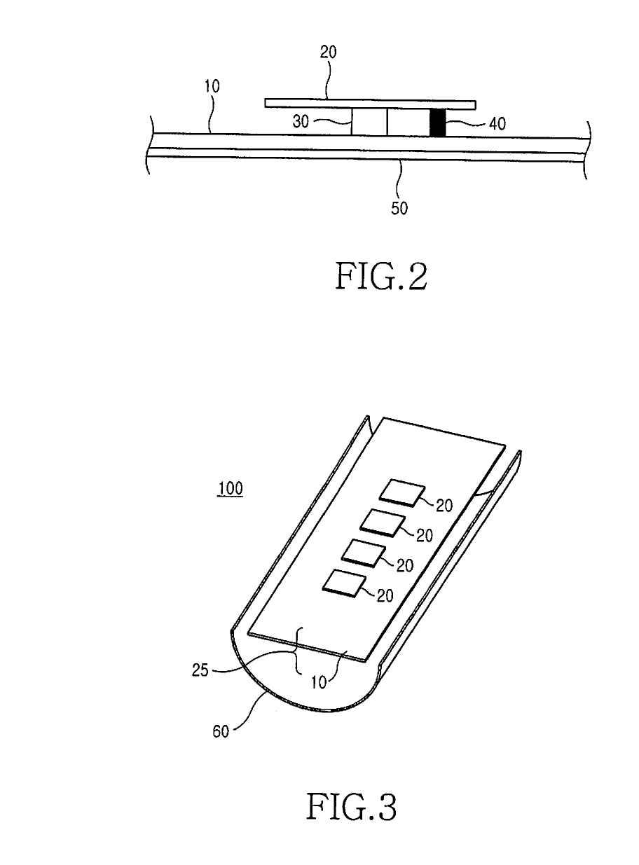

FIG. 2 illustrates a feeding structure for the radiation element 20 for explaining a feeding method that enables the radiation element 20 to radiate electric waves. The support member 30 is attached to one surface of the ground plate 10 and the radiation element 20 is attached to the support member 30. The support member 30 may be formed of metal or an insulator. The feeding circuit 50 is attached to the other surface of the ground plate 10 by means of an insulating layer. The ground plate 10 is structured such that the feeding unit 40 can penetrate the ground plate 10. The feeding unit 40 connects the radiation elements 20 with the feeding circuit 50 by penetrating the ground plate 10. The plurality of radiation elements 20 are arranged along a long side of the ground plate 10, and complete the array antenna 25.

FIG. 3 is a perspective view of the antenna device 100 of the present invention. The antenna device 100 is composed of a combination of the array antenna 25 in which the plurality of radiation elements 20 is arranged on the ground plate 10 and the reflector 60. The array antenna 25 has a characteristic that a main lobe having a strong directivity in an upward direction in FIG. 3 is formed and a side lobe and a back lobe are formed incidentally to the main lobe. For this reason, the reflector 60 may be used as an attenuator for the side lobe and the back lobe without exerting a significant influence upon the characteristics of the main lobe.

Since such a structure does not have a significant influence upon the main lobe of radiating electric waves, the shape and dimension of the radiation elements 20, the number of the radiation elements 20, a disposition interval for the radiation elements 20, the size of the ground plate 10, and an interval between the array antenna 25 and the ground plate 10 can be acquired from the frequency, output power, and required beam pattern of radiating electric waves using a micro-strip antenna designing method.

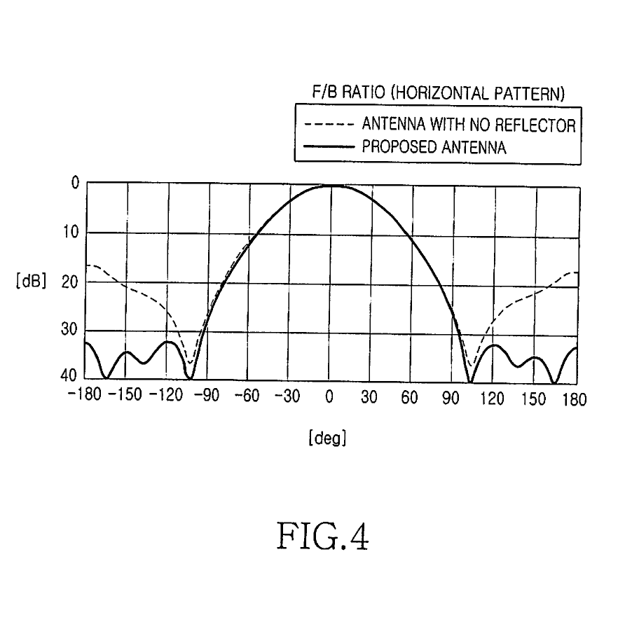

FIG. 4 is a graph showing the characteristics of the Front-to-Back (F/B) ratio of the antenna device 100. A dotted line shows the characteristics of the F/B ratio of an array antenna having no reflector. A solid line shows the characteristics of the F/B ratio of the antenna device 100 of the present invention. For the array antenna having no reflector, influences of the side lobe and the back lobe can be seen at 90° or more from the main lobe to the left and right and it is not possible to decrease the F/B ratio to 20 dB or less.

On the other hand, for the array antenna 25 having the reflector 60, some attenuation is observed around 60° or more from the main lobe, but influences of the side lobe and the back lobe at 90° or more from the main lobe can be decreased to 30 dB or less and an improvement of 10 dB or more can be achieved.

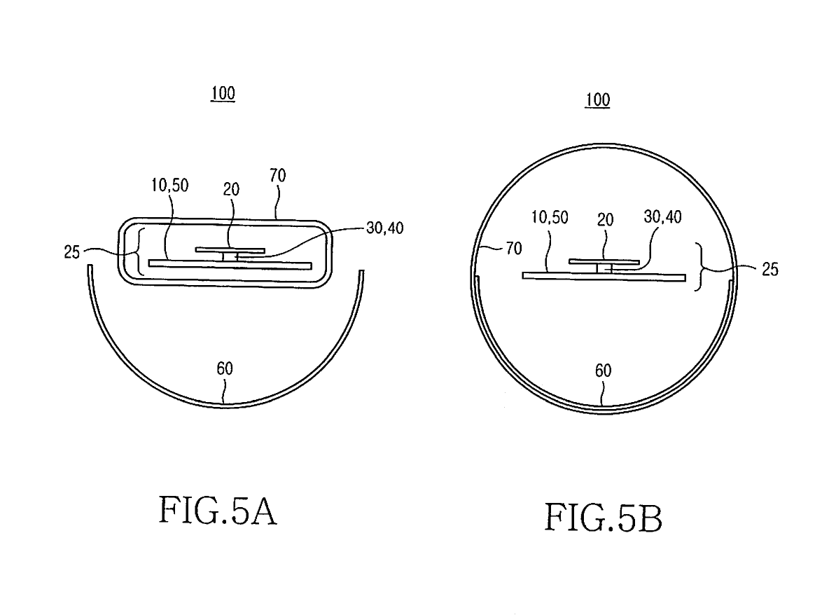

FIGS. 5A and 5B illustrate a mounting structure for the antenna device 100 of the present invention. Referring to FIG. 5A, the array antenna 25 is accommodated in a resin radome 70 and is combined with the reflector 60 as one piece, constituting the antenna device 100. The mounting structure shown in FIG. 5A can easily improve an F/B ratio by mounting the reflector 60 in the antenna device 100 composed of previously installed array antenna 25 and radome 70.

Referring to FIG. 5B, the array antenna 25 and the reflector 60 are accommodated in the resin radome 70 to be integrated as one piece, thereby constituting the antenna device 100. The mounting structure shown in FIG. 5B can provide a small-size and light-weight antenna device capable of resisting wind pressure load. The reflector 60 may be formed by coating the inner circumferential surface of the radome 70 with metal. Alternatively, the reflector 60 may be formed of a metal net formed by etching in the inner circumferential surface of the radome 70.

According to the present invention, the antenna device can be designed using a micro-strip array antenna designing method while improving the F/B ratio by at least 10 dB, to resisting wind pressure load in spite of small size and light weight.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An antenna device comprising:
an array antenna having a plurality of radiation elements arranged on one surface of a rectangular ground plate composed of a short side and a long side; and
a reflector having a conductive material whose cross section approximately forms a half cylinder in a circular arc shape, in which a width between parallel linear end portions corresponding to an arc of the cross section is longer than the short side of the ground plate,
wherein the array antenna is disposed such that the other surface of the ground plate faces an inner wall of a depression part of the reflector and the ground plate is disposed in the same plane as or in nearly the same plane as each of the linear end portions of the reflector.

2. The antenna device of claim 1, wherein the reflector is composed of a lateral side of a cylinder taken along a plane containing the principal axis of the cylinder.

3. The antenna device of claim 1, wherein if the antenna device uses a wavelength of λ, a width between the linear end portions of the reflector is approximately 2λ and the length of the short side of the ground plate is approximately 0.5-1.5λ.

4. The antenna device of claim 1, wherein the reflector includes one of a metal plate, a metal net, and a dielectric coated with metal.

5. The antenna device of claim 1, wherein only the array antenna is accommodated in a resin radome.

6. The antenna device of claim 1, wherein both the array antenna and the reflector are accommodated in a resin radome.

7. The antenna device of claim 6, wherein the reflector is formed by coating an inner circumferential surface of the radome with metal.

8. The antenna device of claim 6, wherein the reflector is formed of a metal net by means of etching in an inner circumferential surface of the radome.
